(19) United States
(12) Patent Application Publication
(10) Pub. No.: US 2010/0091318 A1
(43) Pub. Date: Apr. 15, 2010

(54) SYSTEMS AND METHODS FOR MULTIPLE QUEUE OPTIONS FOR A SINGLE LOGICAL PRINTER

(76) Inventor: Andrew Rodney Ferlitsch, Camas, WA (US)

Correspondence Address: Duft Bornsen & Fishman, LLP, 1526 Spruce Street, Suite 302, Boulder, CO, 80302, US

(21) Appl. No.: 12/248,695

(22) Filed: Oct. 9, 2008

(51) Int. Cl. G06F 3/12

(52) U.S. Cl. 358/1.15

(57) ABSTRACT

Systems and methods for managing multiple spool options for a single printer. A spool option is associated with a print job. The spool option specifies whether the associated print job is ready to print or specifies a scheduled time to print the print job. The print job and its associated spool option are sent to a single logical printer defined in the system. The print job is queued in a queue based on the spool option. In an exemplary embodiment, a first queue is used for print jobs that are ready to be printed and second queue is used for print jobs having spool option specifying a scheduled time to print. Both queues are managed by job spooler functions associated with a single printer in the computing system to eliminate the problems of defining multiple logical printers for different queuing/spool options.

### BACKGROUND

1. Field of the Invention

The invention relates generally to printing systems and application and in particular relates to systems and methods for providing both on-demand and scheduled print spool options for a single installed printer coupled to a computing system.

2. Discussion of Related Art

In computer printing environments an application or user requests a document to be printed by selecting a particular printer and specifying any options desired for the printed output. In most modern day computing environments, the requested print job (with desired parameters) is forwarded to a print spooler that spools/queues the print job request for output in sequence with other print jobs generated by the same or another computer system coupled to the printer. The spooler, in general, saves the print job data in a file and maintains a queue of the print jobs to be printed. Eventually a spooled/queued print job will be dequeued from the print queue by the spooler and transmitted to the printer for outputting.

In general there are two approaches to spooling of jobs—on-demand and scheduled printing. An on-demand job is one that the user intends to be printed immediately (i.e., as soon as it reaches the top of the spooler's queue). In scheduled printing, a job is provided to the spooler with a desired time and/or date for printing. The spooler holds scheduled jobs in a print queue (typically sorted by earliest to latest print time) and dequeues a job for transmission to the printer only when its scheduled print time is reached.

As presently practiced in most computing systems (i.e., operating systems with print spooler capabilities) the type of spooling allowed is defined when the printer is installed by a system administrator. Or, the printer may be configured by a user to perform on-demand spooling for a period of time and re-configured for scheduled printing at some later period of time. As presently practiced, only one type of spool option is defined for a particular identified printer. If a particular computing environment desires simultaneous use of both on-demand and scheduled spool options a common technique is to define/install two logical printers. Each logical printer is configured to use the same physical printer. A first logical printer is configured to use on-demand spooling and the second logical printer is defined to use scheduled spooling. In such a configuration, the user/application program decides when it is ready to print a document whether it should be printed on the logical printer that is configured for on-demand spooling or on the logical printer that is configured for scheduled spooling.

This “workaround” gives rise to various problems. One problem arises in that the system administrator must perform the additional steps of properly configuring two logical printers for the same physical printer. This configuration may be further complicated if the operating system and spooling system is not adapted to coordinate the printing of jobs spooled for multiple logical printers on a single physical printer. Further, creating two logical printers on a computing system may utilize additional resources on the system. In addition, and perhaps most importantly, the user/application must understand the purpose of each of the two logical printers and be careful to select the appropriate spooling configuration for each print job.

It is evident from the above discussion that a need exists for improved systems and methods for enabling support for both on-demand and scheduled spooling on a single printing system.

### SUMMARY OF THE INVENTION

The present invention solves the above and other problems, thereby advancing the state of the useful arts, by providing systems and method for providing both an on-demand spool for printing of jobs and a scheduled spool for printing of other jobs—both spools associated with the same physical printer.

In one aspect an apparatus is provided for spooling print jobs generated by a computing system. The apparatus includes a print job spooler adapted to spool print jobs for printing on an identified printer and a spooler interface coupled with computing system to receive the print jobs from the computing system with identification of the printer. The spooler interface is also coupled with the print job spooler. The spooler interface adapted to receive a spool option from the computing system. The spool option specifies that the print job is to ready to be printed or specifies a scheduled time for the print job to be printed. The print job spooler is operable to add the print job received from the spooler interface to a first queue if the spool option specifies that the print job is ready to be printed and is operable to add the print job to a second queue if the spool option specifies a scheduled time for printing the print job. The print job spooler is operable to dequeue a next print job from the second queue at the scheduled time for printing of the next job and is operable to dequeue a next print job from the first queue if no other print job is presently ready to print at its scheduled time on the first queue. The print spooler is also operable to transmit the next print job to the identified printer associated with the next print job.

Another aspect hereof provides a method and a computer readable medium embodying the method for spool management of print jobs. The method includes generating a print job, associating an identified printer with the print job, and associating a spool option with the print job. The spool option specifies that the print job is ready to be printed or specifies a scheduled time for the print job to be printed. The method also includes selecting a queue from a plurality of queues associated with the identified printer based on the spool option and queuing the print job in the selected queue. The method then dequeues a next print job from one of the plurality of queues based on the spool option associated with each queued print job and transmitting the dequeued next print job to the identified printer associated with the next print job.

Still another aspect hereof provides a system that includes a print job generator that generates a print job to be printed on an identified printer associated with the print job and a spool interface adapted to receive user input indicative of a spool option for spooling the print job for printing on the identified printer. The spool option specifies that the print job is ready to be printed or specifies a scheduled time for the print job to be printed. The system also includes a job spooler coupled to receive the spool option and the print job. The job spooler adapted to queue the print job on one of a plurality of queues associated with the identified printer and in accordance with the spool option. The job spooler further adapted to dequeue a next print job from among any queued print jobs such that a print job associated with a scheduled time for printing spool option is dequeued at the scheduled time for printing and such that a queued print job associated with a ready to print spool option is dequeued otherwise. The print job spooler is further adapted to transmit the next print job to the identified printer.

### BRIEF DESCRIPTION OF THE DRAWINGS

FIG. 1 is a block diagram of an exemplary system for managing multiple spool queues for multiple spool options for print jobs directed to a single printer in accordance with features and aspects hereof.

FIG. 2 is a block diagram of another exemplary system for managing multiple spool queues for multiple spool options for print jobs directed to a single printer in accordance with features and aspects hereof.

FIG. 3 is a flowchart depicting an exemplary method for managing multiple spool queues for multiple spool options for print jobs directed to a single printer in accordance with features and aspects hereof.

FIGS. 4 and 5 are flowcharts depicting exemplary details of steps of the method of FIG. 3.

FIG. 6 is a flowchart depicting another exemplary method for managing multiple spool queues for multiple spool options for print jobs directed to a single printer in accordance with features and aspects hereof.

FIG. 7 is a block diagram of a system including a computer readable medium that may embody methods in accordance with features and aspects hereof.

### DETAILED DESCRIPTION OF THE DRAWINGS

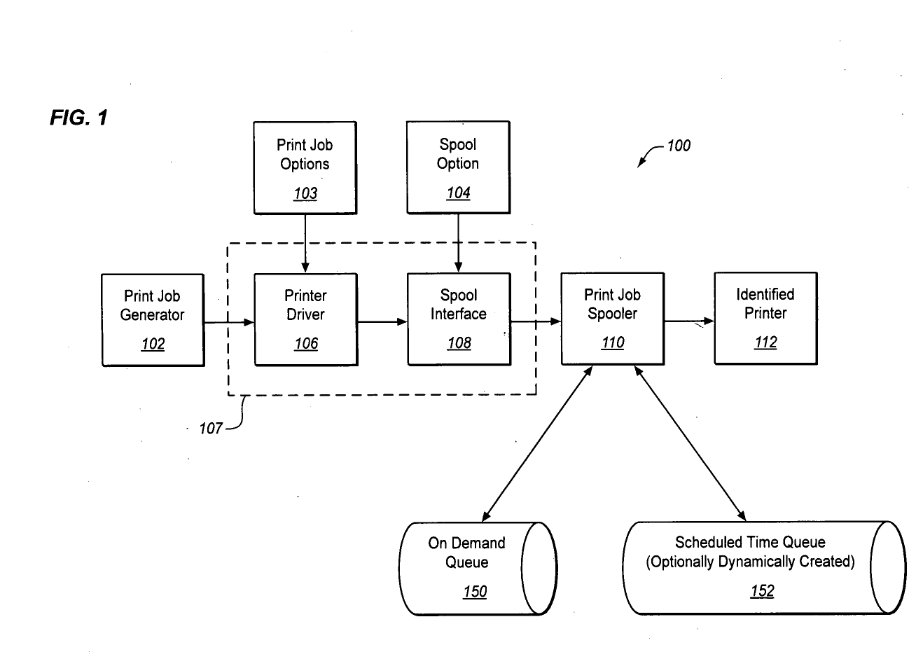

FIG. 1 is a block diagram showing an exemplary system 100 embodying features and aspects hereof to manage multiple queues (e.g., queues 150 and 152) all associated with a single identified printer 112. As noted above, by way of contrast, prior techniques required an administrator to define two (or more) logical printers associated with the same physical printer, each logical printer specifying a different spooling/queuing option. Further, as presently practiced, a user generating a print job would have to identify and select the appropriate logical printer defined by the administrator to utilize the spool option desired for the print job. System 100 of FIG. 1 provides a spool interface 108 that receives a print job from the user or source of a print job 102 and receives an associated spool option 104 for the print job. The spool option 104 associated with a print job indicates either that the print job is ready to be printed (e.g., an “on-demand” print job) or may specify that the print job is to be printed at a scheduled time specified in the spool option. Other print options 103 relating to parameters of the output to be generated (e.g., duplex, N-up, multiple copies, etc.) may also be provided by the user or source of the print job.

The print options 103 and the spool options 104 associated with a print job may be specified, for example, by use of a graphical user interface allowing a user generating the print job to specify print options and spool options for the particular job while selecting the identified printer on which the document is to be printed. Well known dialog boxes or other graphical/textual user interface techniques may be used for such purposes. In addition, the print job generator 102 may utilize an application program interface (API) to access the printer driver 106 and spool interface 108 for purposes of providing print job options 103 and spool options 104. Other similar design choices to associate print and spool options with a print job will be readily apparent to those of ordinary skill in the art.

A first queue (on-demand queue 150) is provided for queuing/spooling of print jobs having an associated spool option specifying that the print job is presently ready to be printed. A second queue (scheduled time queue 152) is provided for queuing/spooling of print jobs having an associated spool option specifying a scheduled time for the print job to be printed. In the exemplary embodiment of FIG. 1, both the first queue 150 and the second queue 152 are managed by print job spooler 110. When a print job is received by printer driver 106 from the source 102 and various print job options 103 are specified for the print job, printer driver 106 interacts with the spool interface 108 to obtain a spool option 104 to be associated with the print job. The print job and the associated spool option are then sent to the print job spooler 110. The job spooler 110 queues the received print job in one of the multiple queues (150 or 152) based on the spool option provided with the print job. Where the spool option indicates that the received print job is presently ready to be printed, spooler 110 queues the print job in the first print queue 150 (the on-demand queue). If the spool option associated with the received print job indicates that the print job is to be printed at a specified scheduled time, spooler 110 queues the received print job on the second queue 152 (the scheduled time queue).

Print job spooler 110 continuously performs background processing to determine when the identified printer 112 is ready for a next print job. When the identified printer 112 is ready to receive a next print job, spooler 110 dequeues a next print job from one of the multiple queues (150 or 152) based on the spool options for all the queued jobs. For example, spooler 110 may first examine the second queue 152 to determine if any jobs queued therein are presently ready to be printed by virtue of encountering the scheduled time for the printing of one or more queued jobs. If a print job queued in the scheduled time queue 152 is now ready to be printed based on its associated spool option scheduled time, the print job is dequeued by spooler 110 and transmitted to the identified printer 112 to be imprinted on appropriate printable media. If no jobs are presently ready to be printed in the scheduled time queue 152, spooler 110 may then examine the on-demand queue 150 to determine if any print jobs are ready to be printed. If any print job is found in the on-demand queue 150, spooler 110 dequeues a next print job from the on-demand queue 150 and transmits the next print job to the identified printer 112 for printing on suitable printable media.

As noted in FIG. 1, in one exemplary embodiment of the invention, the scheduled time queue 152 may optionally be dynamically created in response to receipt of a first print job by spooler 110 with a spool option indicating a scheduled time for the received print job to be printed. In some system applications, such dynamic creation of the scheduled time queue may be advantageous in conserving resources until such time as a scheduled print job is received by the print job spooler 110.

The various elements depicted in FIG. 1 may be integrated within one or more suitable computing systems. For example, printer driver 106 and spool interface 108 may be integrated as indicated by dashed line 107 within a single computing system such as a personal computer or workstation in a networked environment. Multiple such personal computing systems or workstations may be coupled via a network to a common print job spooler 110 operable in a separate and distinct computing system in the same network environment. Print job generator 102, print job options 103, and spool option 104 may generally be provided by elements operable within the same computing system in which printer driver 106 and spool interface 108 are operable. Alternatively, for example, all the depicted elements (other than the printer 112 per se) may be integrated within a single computing system operable either in a standalone application environment or in a networked computing environment. Alternatively, for example, all the depicted elements (other than the printer 112 per se) may be integrated within a cloud computing service external to the user and accessed via the Internet as a Software-as-a-Service (SaaS).

Those of ordinary skill in the art will readily recognize numerous additional and equivalent elements in a fully functional system 100 as shown FIG. 1. Such additional and equivalent elements are omitted herein for simplicity and brevity of this discussion.

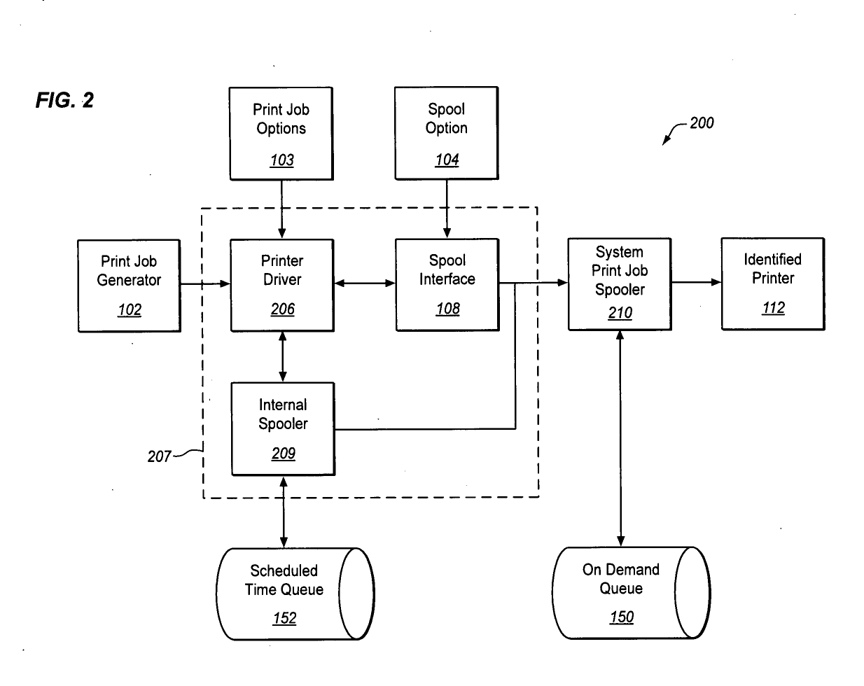

FIG. 2 depicts another exemplary embodiment of a system 200 providing support for multiple spooling/queuing options for a single identified printer 112. System 200 is similar to system 100 a FIG. 1 in that two queues are maintained—a first queue 150 for queuing/spooling of print jobs having a spool option specifying that the print job is presently ready to be printed and a second queue 152 for queuing/spooling of print jobs having a spool option specifying a scheduled time for the associated print job to be printed. By contrast to system 100 of FIG. 1, system 200 of FIG. 2 utilizes a standard system print job spooler 210 to manage a single queue for a single spool option for the identified printer 112. In particular, system print job spooler 210 manages a single queue 150 for queuing/spooling of on-demand print jobs presently ready to be printed. System print job spooler 210 may be, for example, a standard print job spooler as is generally present in various commercially available operating systems including, for example, Microsoft Windows, Unix, Linux, etc. Such a standard system print job spooler 210, as discussed above, is generally capable of managing only one type of spool option for an identified printer 112. Thus, an internal spooler 209 associated with the printer driver 206 manages a second queue 152 for queuing of print jobs having a spool option specifying a scheduled time for the associated job to be printed.

When printer driver 206 of FIG. 2 receives a print job and its associated print job options 103, it interacts with spool interface 108 to receive a spool option provided by the user/generator of the print job. If the spool option indicates that the print job is an on-demand job, and thus ready to be printed, the print job and its associated spool option are forwarded directly to the system print job spooler 210 to be managed in the first queue 150 (the on-demand queue). If the spool option provided to printer driver 206 by spool interface 108 specifies that the print job is to be printed at a scheduled time, printer driver 206 retains control of the print job and forwards it to internal spooler 209 to be added to the scheduled time queue 152 (a second queue).

Internal spooler 209 and system print job spooler 210 then operate in a cooperative manner to assure proper printing of all queued print jobs. In particular, internal spooler 209 monitors the print jobs queue in the second queue 152 (the scheduled time queue) to detect when any queued job is now ready to be printed based on its scheduled time. When a print job queued in the second queue 152 is determined to be ready for printing by operation of internal spooler 209 (by encountering its scheduled time), the print job is dequeued from the second queue 152 by internal spooler 209 and forwarded from the internal spooler 209 to the system print job spooler 210 as a print job now ready to be printed—in essence, converted from a scheduled time print job to an on-demand print job by encountering its scheduled time to be printed. The system print job spooler 210 then adds the received job (now ready to be printed based on its scheduled time) to the first queue 150. System spooler 210 then operates essentially as discussed above to monitor the identified printer 112 to determine when it is ready to receive a next print job. When printer 112 is ready to receive a next print job, spooler 210 dequeues a next print job from the on-demand queue 150 (the first queue) and transmits the next print job to the identified printer 112.

As noted above in FIG. 1, the second queue 152 may be dynamically created in response to receipt of a first print job with a spool option indicating a scheduled time to be printed. Such dynamic creation of the second queue 152 may conserve resources in particular applications where scheduled time print jobs are less common. For example, in some systems a thread is spawned to monitor the queue object (for purposes of dequeuing print jobs in background processing). Creating the queue thus entails creating a monitoring thread which consumes resources on the computing system on which it runs. If a queue is infrequently used, such as an occasional scheduled time print job, the computing system may conserve computing resources to create the queue (and the corresponding monitoring thread) only when a first job is received that may require the corresponding queue. In like manner, if a queue is no longer in use (e.g., after a period of time with no jobs queued therein) the queue and its corresponding monitor thread may be destroyed to free resources for other use in the computing system on which it is instantiated. Further, those of ordinary skill in the art will recognize numerous additional and equivalent elements in a fully operational system 200 as shown in FIG. 2. Such additional and equivalent elements are omitted herein for simplicity and brevity of this discussion.

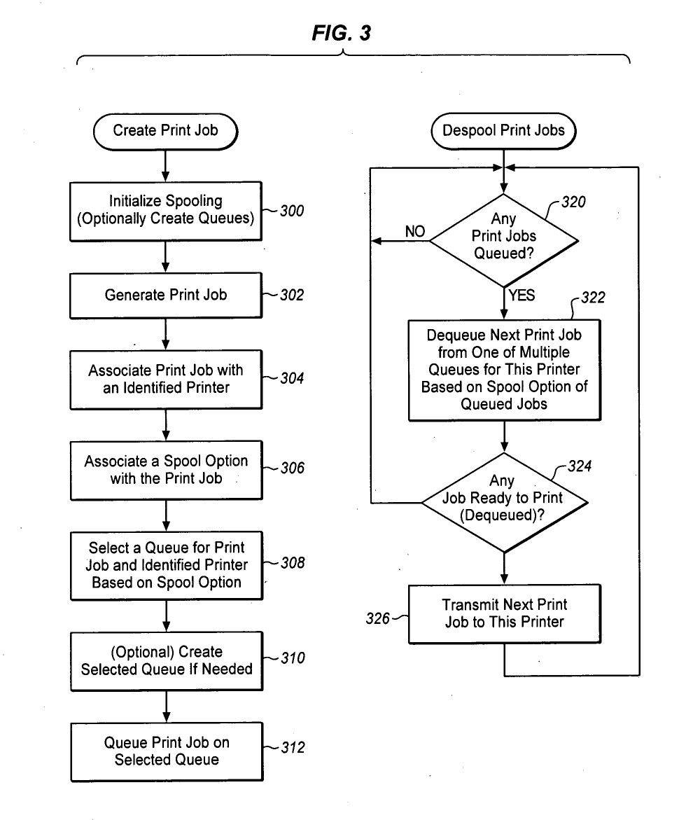

FIG. 3 is a flowchart describing an exemplary method in accordance with features and aspects hereof to manage multiple spool options for a single, identified printer thus obviating the complexity of defining and utilizing multiple logical printers for a single physical printer as presently practiced in the art. Step 300 represents suitable processing to initialize spooling operations of the system including, optionally, creating one or more spooling queues associated with an identified printer. As noted above, queues for the various spool options associated with each print job for an identified printer may be created when the system is initialized by processing of this step 300 or queue creation may be deferred until a later time when the first print job associated with a particular spool option is received to thereby conserve resources in particular applications. Step 302 then generates a new print job. A print job may be created by a user in conjunction with an application program requesting that a particular document be printed and associating particular printing features are options with the print job. Step 304 then associates the generated print job with an identified printer—specifically the printer associated with the one or more spooling queues created above (or subsequently created when a first job is received).

Step 306 associates a spool option with the newly generated print job associated with the identified printer. As distinct from prior practices, step 306 allows a user or application program to request a particular spool option for the generated print job already associated with an already identified printer. For example, a first spool option may indicate that the generated print job is presently ready to be printed (e.g., an on-demand print job) and a second spool option may indicate that the generated print job is to be printed at a scheduled time specified by the user with the spool option.

At step 308, the print job with its associated spool option is then provided to an appropriate spooler that selects a queue for the print job and the identified printer based on the specified spool option. For example, where the spool option for the print job indicates that it is ready to be printed (e.g., and on-demand print job) a first queue may be selected by step 308 while a second queue may be selected where the spool option for the print job specifies a scheduled time for the print job to be printed. Step 310 optionally creates any queue that is required upon receipt of a first print job specifying a particular spool option associated with a queue. For example, the first print job received by the spooling system specifying a scheduled time to be printed may cause the spooling system to create the second queue used for spooling/queuing of such scheduled time print jobs. Further, it will be noted that a plurality of scheduled time queues may be created such that each queue is associated with a particular scheduled time. Thus if multiple jobs are generated with the same scheduled time spool option, all those scheduled time jobs will be added to the same scheduled time queue. Other scheduled time jobs associated with other scheduled time will be added to a corresponding queue associated with that particular scheduled time. This may be useful, for example, where an environment generates multiple standard print jobs at a first standard time (e.g., midnight) and another group of print jobs scheduled at another standard time (e.g., mid-afternoon). Step 312 then queues the received print job on the selected queue—selected based on the spool option associated with the received print job by step 308.

Steps 320 through 326 represent additional processing asynchronous with respect to the creation of a new print job as described above in steps 300 through 312. In general, the spooling system performs background processing to determine when the next print job should be transmitted to the identified printer. When an identified printer is ready for a next print job, step 320 in the spooler determines whether any print jobs are presently queued in any of the multiple queues associated with the identified printer. If not, processing continues looping in the background until an identified printer, ready for to receiving next print job, has a job queued in any of its associated queues. Upon detection of a job queued for an identified printer ready to receive the next print job, step 322 dequeues a next print job from one of the multiple queues for this identified printer based on the spool options of the various queued jobs. For example, if the scheduled time for printing of a print job specifying a scheduled time to be printed has been encountered, that scheduled time print job is dequeued as the next print job to be transferred to be identified printer. If no scheduled time print job is presently ready to be printed, on-demand print jobs on another queue within the spooling system may be dequeued as the next print job to be transferred to the identified printer. Step 324 then determines whether any print job was successfully identified and dequeued by operation step 322 as the next print job to be transferred to the identified printer. If not, processing loops back to step 320 to repeat the processing until such a print job is identified in the various queues associated with the identified printer. If a next print job was successfully dequeued by step 322, step 326 transmits the next print job to the identified printer to generate the desired output for the print job. Processing then loops back to step 320 to continue background processing for dequeuing a next print job at the appropriate time for printing of each queued print job.

Those of ordinary skill in the art will recognize that the that the exemplary method of FIG. 3 may be implemented in a manner where multiple queues are managed by a common system spooler or it may be implemented where management of the various queues is distributed among multiple spoolers including, for example, a system spooler and a second internal spooler associated with the printer driver. Details of such an exemplary second embodiment where management of multiple queues is distributed among multiple spoolers is discussed further herein below.

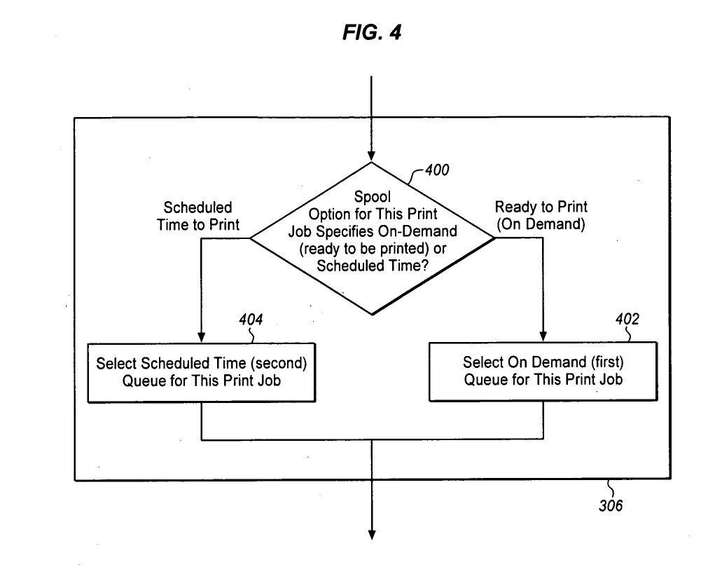

FIG. 4 is a flowchart describing exemplary additional details of the processing of step 306 of FIG. 3 to select an appropriate queue from among multiple queues based on the spool option associated with a print job. Step 400 first determines what spool option is associated with a received print job. If step 400 determines that the spool option specifies that the received print job is ready to be printed (e.g., an on-demand print job) step 402 selects the on-demand queue (the first queue) for queuing of this received print job. If step 400 determines that the spool option specifies a scheduled time for the received print job to be printed, step 404 selects the scheduled time queue (the second queue) for queuing of this print job. The selected queue (first queue or second queue) is then returned as the result of the processing of step 306 and further processing of the method of FIG. 3 then queues the job on the selected queue.

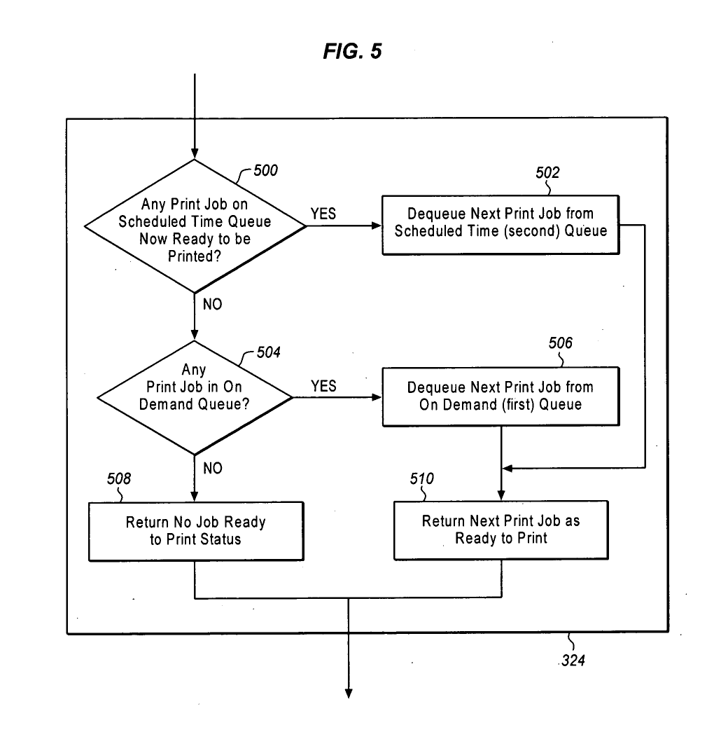

FIG. 5 is a flowchart depicting exemplary additional details of the processing of step 324 of FIG. 3 to dequeue a next print job for an identified printer from among the various queues associated with the identified printer and in accordance with the spool option for the print jobs queued therein. Step 500 first determines whether any print job is presently queued in the second queue (the scheduled time queue) for which the scheduled time has been encountered. If so, step 502 dequeues the next print job from the scheduled time queue and step 510 provides the dequeued next print job as the result of step 324 for further processing in the method of FIG. 3. If step 500 determines that no job in the scheduled time queue has yet encountered its corresponding scheduled time to be printed, step 504 next determines whether any print job is queued in the on-demand queue (the first queue). If so, step 506 dequeues the next print job from the on-demand queue and step 510 then returns the next print job as ready to be printed for further processing in the method of FIG. 3. If step 504 determines that there exists no print job in the on-demand queue, step 508 returns a status indication that no next job has been the queued—i.e., no job is presently ready to be printed either on-demand or at a scheduled time. This status of step 508 or the next print job returned by step 510 is provided as the output of step 324 for further processing in the method of FIG. 3.

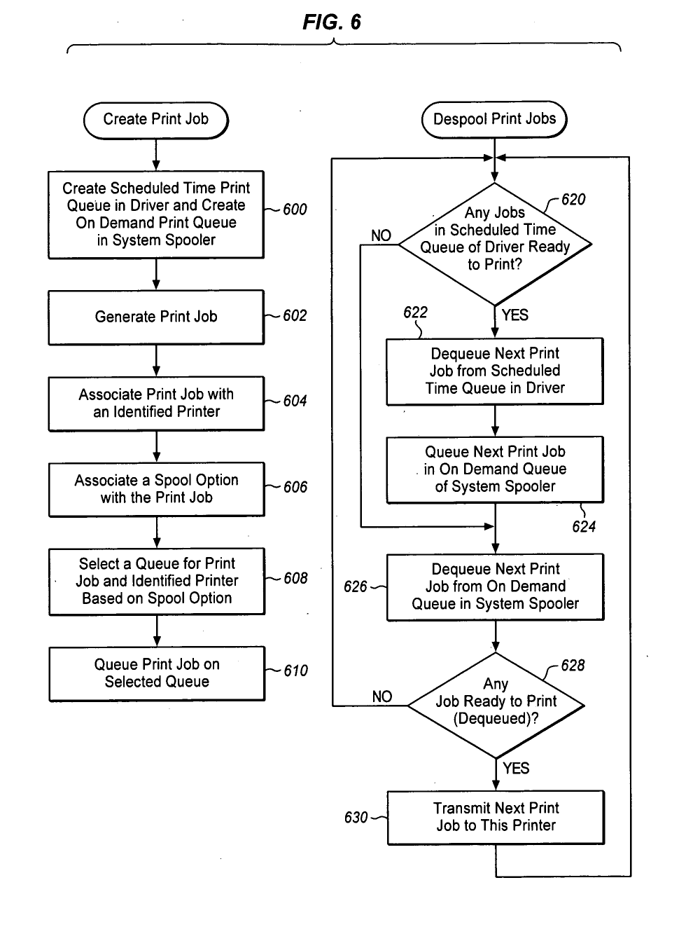

FIG. 6 is a flowchart depicting another exemplary method in accordance with features and aspects hereof to manage multiple spool options for print jobs to be printed on a single identified printer. The method of FIG. 6 is similar to that of FIG. 3 but provides that the second queue (the scheduled time queue) may be implemented internally within the printer driver while the first queue (the on-demand queue) may be managed within a system spooler of the computing system. This exemplary embodiment advantageously permits use of the system's standard spooler without need for modification by providing a second queue (the scheduled time queue) within a modified printer driver operable in cooperation with the standard system spooler. Steps 600 through 610 represent processing to create a new job and queue the print job in an appropriate queue for later dequeuing and transmission to the identified printer. Steps 620 through 630 represent background processing of the spooling features—generally asynchronous with respect to steps 600 through 610 to generate a print job to be queued.

Step 600 represents processing to create a scheduled time queue (the second queue) in the printer driver and to create the on-demand queue (the first queue) in the system spooler. Step 600 may be performed as part of the standard initialization of the spooling system and printer driver or, as noted above, creation of the various queues may be deferred until such time as the first print job with a corresponding spool option for a particular queue is generated. Step 602 represents any processing to generate a print job such as a user utilizing an application program or any other suitable processing to create a print job or retrieve a previously created print job for transmission to an identified printer. Step 604 associates the new print job with an identified printer. Well known user interface or application program interface techniques may be utilized in the processing of step 604 to associate an identified printer with the newly generated print job. Step 606 then associates a spool option with the newly generated print job. For example, a first spool option may indicate that the print job is presently ready to be printed (e.g., an on-demand print job). A second spool option may indicate that the print job is to be printed at a specified, scheduled time. Well known user interface and application program interface techniques may also be used for the processing of step 606 to associate a particular spool option with the newly generated print job. Step 608 then selects an appropriate queue for queuing the newly generated print job based on the identified printer and the spool option associated with the newly generated print job. As noted, the first queue (the on-demand queue) may be managed within the standard system spooler while the second queue (the scheduled time queue) may be managed within an internal spooler associated with the printer driver. Step 610 then queues the newly generated print job on the queue selected by step 608. Where the newly generated job specifies a spool option for a scheduled time to be printed, the print job will be queued on the selected second queue implemented within the spooler of the print driver. Where the newly generated job specifies a spool option for an on-demand print job, the print job will be forwarded to the system spooler for queuing on the first queue (implemented internally to the printer driver).

Steps 620 through 630 represent background processing of spooling features to dequeue a next print job (asynchronous with respect to the creation of a new job as discussed above with respect to steps 600 through 610). Step 620 represents background processing of the internal spooler integrated with the printer driver to determine whether any jobs in the scheduled time queue (the second queue) are now ready to be printed (e.g., the scheduled time for a job has been encountered). If so, the step 622 dequeues the next print job from the scheduled time queue implemented within the internal spooler of the printer driver and step 624 queues that next job to be printed in the on-demand queue of the system spooler. More specifically, the job dequeued from the scheduled time queue (the second queue) within the printer driver will be forwarded to the system spooler to be queued in its on-demand queue (the first queue). Processing then continues at step 626 as discussed below. If step 620 determines that no job is in the scheduled time queue of the internal spooler of the printer driver that is now ready to be printed at its scheduled time, processing continues at step 626.

Step 626 is performed within the system spooler to dequeue a next print job from its on-demand queue (the first queue). It will be noted by those of ordinary skill in the art that a scheduled time print job dequeued from the second queue (implemented within the internal spooler of the printer driver) will have been added to the on-demand queue of the system spooler. Step 628 then determines whether any next print job was successfully dequeued from the on-demand queue of the system spooler. If not, processing continues looping back to step 620 to await dequeuing of the next print job. If step 628 determines that the next job was successfully dequeued from the on-demand queue of the system spooler, step 630 transmits this next print job to the identified printer associated with the managed queues. Processing then continues looping back to step 620 to continue background processing to dequeue a next print job when the identified printer is ready for a next print job.

In one exemplary embodiment, the internal spooler may be implemented within the driver module as a queue with a monitoring thread instantiated when a scheduled time job is received and destroyed when the queue is emptied (all scheduled jobs in the internal spooler have been forwarded to the system spooler in response to their scheduled times being encountered). In essence, when the driver receives a scheduled time print job it first inspects to determine if such a queue with monitor thread has already been instantiated. If not, the queue and its monitoring thread are instantiated. The newly received scheduled time print job is added to the internal spooler queue of the driver. When a scheduled time job is dequeued by the monitoring thread and forwarded to the systems spooler, the monitoring thread determines whether the queue is now empty and, if so, the thread and queue are destroyed to free resources within the system.

Those of ordinary skill in the art will readily recognize numerous additional features that may be implemented in the management of each of the multiple queues. For example, well known job prioritization techniques may be applied to the reorder queued jobs within each queue such that higher priority jobs will be dequeued and sent to the identified printer before lower priority jobs. Or, for example, the size of a job may be a factor in determining the order in which multiple jobs are queued in each of the various queues such that smaller jobs or larger jobs may be queued with a higher priority. These and other design choices in further queue management will be readily apparent to those of ordinary skill in the art.

Further, those of ordinary skill in the art will readily recognize numerous additional and equivalent steps for the methods of FIGS. 3 through 6. Such additional and equivalent steps are omitted herein for simplicity and brevity of this discussion.

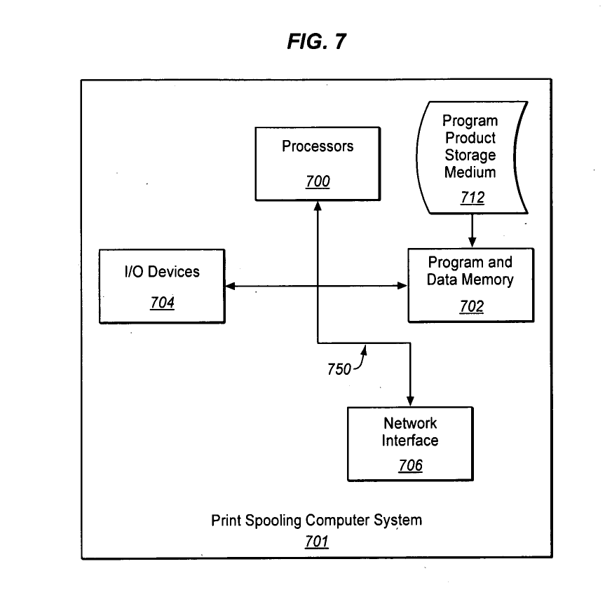

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, etc. FIG. 7 is a block diagram depicting a print spooling computer system 701 as a system adapted to provide features and aspects hereof by executing programmed instructions and accessing data stored on a computer readable storage medium 712.

Furthermore, the invention can take the form of a computer program product accessible from a computer-usable or computer-readable medium 712 providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor 700 coupled directly or indirectly to memory elements 702 through a system bus 750. As noted above, processors may be distributed among various control elements of a printing system such as in a rasterizing printer controller and a page extractor post-processing element. The memory elements can include local memory employed during actual execution of the program code, bulk storage, and cache memories which provide temporary storage of at least some program code in order to reduce the number of times code must be retrieved from bulk storage during execution.

Input/output or I/O devices 704 (including but not limited to keyboards, displays, pointing devices, etc.) can be coupled to the system either directly or through intervening I/O controllers. Network adapter interfaces 706 may also be coupled to the system to enable the data processing system to become coupled to other data processing systems or storage devices through intervening private or public networks. Modems, cable modems, IBM Channel attachments, SCSI, Fibre Channel, and Ethernet cards are just a few of the currently available types of network or host interface adapters.

While the invention has been illustrated and described in the drawings and foregoing description, such illustration and description is to be considered as exemplary and not restrictive in character. Various embodiments of the invention and minor variants thereof have been shown and described. In particular, those of ordinary skill in the art will readily recognize that exemplary methods discussed above may be implemented as suitably programmed instructions executed by a general or special purpose programmable processor or may be implemented as equivalent custom logic circuits including combinatorial and/or sequential logic elements. Protection is desired for all changes and modifications that come within the spirit of the invention. Those skilled in the art will appreciate variations of the above-described embodiments that fall within the scope of the invention. As a result, the invention is not limited to the specific examples and illustrations discussed above, but only by the following claims and their equivalents.

What is claimed is:

1. Apparatus for spooling print jobs generated by a computing system, the apparatus comprising:
a print job spooler adapted to spool print jobs for printing on an identified printer; and
a spooler interface coupled with computing system to receive the print jobs from the computing system with identification of the printer, the spooler interface also coupled with the print job spooler, the spooler interface adapted to receive a spool option from the computing system, wherein the spool option specifies that the print job is ready to be printed or specifies a scheduled time for the print job to be printed,
wherein the print job spooler is operable to add the print job received from the spooler interface to a first queue if the spool option specifies that the print job is ready to be printed and is operable to add the print job to a second queue if the spool option specifies a scheduled time for printing the print job,
wherein the print job spooler is operable to dequeue a next print job from the second queue at the scheduled time for printing of the next job,
wherein the print job spooler is operable to dequeue a next print job from the first queue if no other print job is presently ready to print at its scheduled time on the first queue, and
wherein the print spooler is operable to transmit the next print job to the identified printer associated with the next print job.

2. The apparatus of claim 1
wherein the print job spooler comprises a system spooler adapted to utilize both the first queue and the second queue.

3. The apparatus of claim 1
wherein the print job spooler further comprises:
a system spooler integrated within an operating system of the computing system and adapted to utilize the first queue for queuing and dequeuing print jobs associated with a spool option that specifies the print job is ready to be printed for the identified printer; and
a driver spooler integrated within a driver module for the identified printer within the computing system and adapted to utilize the second queue to queue and dequeue for print jobs associated with a spool option that specifies a scheduled time for printing the print job,
wherein the driver spooler is adapted to dequeue a next print job from the second queue when the scheduled time to print the next print job is encountered, and
wherein the driver spooler is further adapted to transmit the next print job to the system spooler as a print job ready to be printed.

4. The apparatus of claim 1 further comprising:
a driver module in the computer system coupling the computer system with the spooler interface and adapted to transmit print jobs from the computer system to the spooler interface with an associated spool option,
wherein the print job spooler is adapted to create the second queue in response to receipt of a print job with an associated spool option indicating a scheduled time for printing the print job.

5. The apparatus of claim 4
wherein the print job spooler is further adapted to destroy the second queue in response to dequeuing the last print job in the second queue.

6. The apparatus of claim 4
wherein the print job spooler is further adapted to associate the first queue and the second queue with the identified printer.

7. A method for spool management of print jobs, the method comprising:
generating a print job;
associating an identified printer with the print job;
associating a spool option with the print job wherein the spool option specifies that the print job is ready to be printed or specifies a scheduled time for the print job to be printed;
selecting a queue from a plurality of queues associated with the identified printer based on the spool option;
queuing the print job in the selected queue;
dequeuing a next print job from one of the plurality of queues based on the spool option associated with each queued print job; and
transmitting the dequeued next print job to the identified printer associated with the next print job.

8. The method of claim 7
wherein the step of selecting further comprises:
selecting a first queue for the print job when the associated spool option indicates that the print job is ready to be printed; and
selecting a second queue for the print job when the associated spool option indicates a scheduled time for the print job to be printed.

9. The method of claim 7 further comprising:
creating a first queue during initialization of a system spooler for queuing print jobs associated with a spool option specifying that the print job is ready to be printed; and
creating a second queue in the system spooler for queuing print jobs associated with a spool option specifying a scheduled time for printing of the print job, wherein the second queue is created in response to receiving a first print job associated with a spool option specifying a scheduled time for printing of the print job.

10. The apparatus of claim 9 further comprising:
destroying the first queue in response to dequeuing the last print job in the first queue; and
destroying the second queue in response to dequeuing the last print job in the second queue.

11. The method of claim 7 further comprising:
creating a first queue during initialization of a system spooler for queuing print jobs associated with a spool option specifying that the print job is ready to be printed; and
creating a second queue in a printer driver for the identified printer for queuing print jobs associated with a spool option specifying a scheduled time for printing of the print job,
wherein the step of selecting a queue further comprises:
selecting the second queue for queuing a print job associated with a spool option specifying a scheduled time for the print job to be printed; and
selecting the first queue for queuing a print job associated with a spool option specifying that the print job is ready to be printed,
wherein the step of dequeuing a next print job further comprises:
dequeuing the next print job from the second queue when the scheduled time to print the print job is encountered; and
queuing the next print job on the second queue.

12. A computer readable medium tangibly embodying programmed instructions which, when executed on a suitable computer system, perform a method for spool management of print jobs, the method comprising:
generating a print job;
associating an identified printer with the print job;
associating a spool option with the print job wherein the spool option specifies that the print job is ready to be printed or specifies a scheduled time for the print job to be printed;
selecting a queue from a plurality of queues associated with the identified printer based on the spool option;
queuing the print job in the selected queue;
dequeuing a next print job from one of the plurality of queues based on the spool option associated with each queued print job; and
transmitting the dequeued next print job to the identified printer associated with the next print job.

13. The computer readable medium of claim 12
wherein the step of selecting further comprises:
selecting a first queue for the print job when the associated spool option indicates that the print job is ready to be printed; and
selecting a second queue for the print job when the associated spool option indicates a scheduled time for the print job to be printed.

14. The computer readable medium of claim 12 the method further comprising:
creating a first queue during initialization of a system spooler for queuing print jobs associated with a spool option specifying that the print job is ready to be printed; and
creating a second queue in the system spooler for queuing print jobs associated with a spool option specifying a scheduled time for printing of the print job, wherein the second queue is created in response to receiving a first print job associated with a spool option specifying a scheduled time for printing of the print job.

15. The apparatus of claim 14 the method further comprising:
destroying the first queue in response to dequeuing the last print job in the first queue; and
destroying the second queue in response to dequeuing the last print job in the second queue.

16. The computer readable medium of claim 12 the method further comprising:
creating a first queue during initialization of a system spooler for queuing print jobs associated with a spool option specifying that the print job is ready to be printed; and
creating a second queue in a printer driver for the identified printer for queuing print jobs associated with a spool option specifying a scheduled time for printing of the print job,
wherein the step of selecting a queue further comprises:
selecting the second queue for queuing a print job associated with a spool option specifying a scheduled time for the print job to be printed; and
selecting the first queue for queuing a print job associated with a spool option specifying that the print job is ready to be printed,
wherein the step of dequeuing a next print job further comprises:
dequeuing the next print job from the second queue when the scheduled time to print the print job is encountered; and
queuing the next print job on the second queue.

17. A system comprising:
a print job generator that generates a print job to be printed on an identified printer associated with the print job;
a spool interface adapted to receive user input indicative of a spool option for spooling the print job for printing on the identified printer, wherein the spool option specifies that the print job is to ready to be printed or specifies a scheduled time for the print job to be printed; and
a job spooler coupled to receive the spool option and the print job, the job spooler adapted to queue the print job on one of a plurality of queues associated with the identified printer and in accordance with the spool option, the job spooler further adapted to dequeue a next print job from among any queued print jobs such that a print job associated with a scheduled time for printing spool option is dequeued at the scheduled time for printing and such that a queued print job associated with a ready to print spool option is dequeued otherwise,
wherein the print job spooler is further adapted to transmit the next print job to the identified printer.

18. The system of claim 17
wherein the plurality of queues comprises:
a first queue used by the job spooler to queue print jobs associated with a spool option indicating that the print job is ready to be printed; and
a second queue used by the job spooler to queue jobs associated with a spool option specifying a scheduled time for the print job to be printed.

19. The system of claim 18
wherein the print job spooler comprises a system spooler adapted to utilize both the first queue and the second queue.

20. The system of claim 18 further comprising a driver module
a driver module coupled to receive the print job from the print job generator and coupled to transmit the print job to the spool interface,
wherein the print job spooler further comprises:
a system spooler adapted to utilize the first queue for queuing and dequeuing print jobs associated with a spool option that specifies the print job is ready to be printed for the identified printer; and
a driver spooler integrated within the driver module for the identified printer and adapted to utilize the second queue to queue and dequeue for print jobs associated with a spool option that specifies a scheduled time for printing the print job,
wherein the driver spooler is adapted to dequeue a next print job from the second queue when the scheduled time to print the next print job is encountered, and
wherein the driver spooler is further adapted to transmit the next print job to the system spooler through the spool interface as a print job ready to be printed.

21. The apparatus of claim 18
wherein the print job spooler is adapted to create the second queue in response to receipt of a print job with an associated spool option indicating a scheduled time for printing the print job.
